(19) United States
(12) Patent Application Publication
(10) Pub. No.: US 2025/0317423 A1
(43) Pub. Date: Oct. 9, 2025

(54) ENCRYPTION SYSTEM AND ENCRYPTION METHOD

(71) Applicant: Sumitomo Electric Industries, Ltd., Osaka-shi, Osaka (JP)

(72) Inventors: Takanori MIYOSHI, Osaka-shi, Osaka (JP); Shota SHIMIZU, Osaka-shi, Osaka (JP); Masato IZAWA, Osaka-shi, Osaka (JP); Isao KATO, Osaka-shi, Osaka (JP)

(73) Assignee: Sumitomo Electric Industries, Ltd., Osaka-shi, Osaka (JP)

(21) Appl. No.: 18/867,038

(22) PCT Filed: Apr. 14, 2023
(86) PCT No.: PCT/JP2023/015148

§ 371 Date: Nov. 19, 2024

(30) Foreign Application Priority Data
May 25, 2022 (JP) 2022-085213

(51) Int. Cl. H04L 9/40

(52) U.S. Cl. CPC H04L 63/0428

(57) ABSTRACT

An encryption system includes a management device, an encryption device and a decryption device. The encryption device and the decryption device are connected to each other via a first transmission line serving as a physical transmission path, the management device is configured to transmit encryption information to the encryption device and the decryption device, the encryption information relating to an encryption scheme used in the encryption device and the decryption device, the encryption device is configured to generate encrypted data by performing an encryption process on communication data, based on the encryption information received from the management device, and to transmit the generated encrypted data to the decryption device via the first transmission line, and the decryption device is configured to perform a decryption process on the encrypted data received from the encryption device via the first transmission line, based on the encryption information received from the management device.

### TECHNICAL FIELD

The present disclosure relates to an encryption system and an encryption method. This application claims priority based on Japanese Patent Application No. 2022-85213 filed on May 25, 2022, and the entire contents of the Japanese patent application are incorporated herein by reference.

### BACKGROUND ART

Patent literature 1 (Japanese Unexamined Patent Application Publication No. 2001-7797) discloses the following encryption communication system. In the encryption communication system, multiple terminal devices are connected to a network via an encryption device having a table in which at least terminal information and cryptographic key information are registered in correspondence with each other. Each encryption device includes a confirmation means, a key search packet transmitting means, and a setting means. When each encryption device receives communication data from the terminal device, the confirmation means confirms whether cryptographic key information corresponding to the terminal information and application type is present in the table. When the confirmation means confirms that the corresponding cryptographic key information is not registered, the key search packet transmitting means transmits a key search packet that sets terminal information, application type, and cryptographic key information of the communication data. The setting means sets cryptographic key information corresponding to the application type in tables of the encryption device of the transmission source of the key search packet and each encryption device located on a relay path for relaying the key search packet based on a key search response packet returned from the destination terminal device in response to the key search packet transmitted by the key search packet transmission means.

Patent literature 2 (Japanese Unexamined Patent Application Publication No. 2020-145672) discloses a method of exchanging a combined cryptographic key between a first node and a second node as follows. In the method, the first node and the second node are connected through a first communication network and a second communication network, wherein the first communication network is a quantum communication network wherein information is encoded on weak light pulses, and the first node and the second node exchange one or more first cryptographic keys on the first communication network, exchange one or more second cryptographic keys on the second communication network, and form the combined cryptographic key by combining the one or more first cryptographic keys and the one or more second cryptographic keys, such that the first node and the second node share knowledge of the combined cryptographic key.

### CITATION LIST

### Patent Literature

Patent literature 1: Japanese Unexamined Patent Application Publication No. 2001-7797

Patent literature 2: Japanese Unexamined Patent Application Publication No. 2020-145672

### SUMMARY OF INVENTION

An encryption system of the present disclosure includes: a management device, an encryption device; and a decryption device. The encryption device and the decryption device are connected to each other via a first transmission line serving as a physical transmission path, the management device is configured to transmit encryption information to the encryption device and the decryption device, the encryption information being related to an encryption scheme to be used in the encryption device and the decryption device, the encryption device is configured to generate encrypted data by performing an encryption process on communication data, based on the encryption information received from the management device, and to transmit the generated encrypted data to the decryption device via the first transmission line, and the decryption device is configured to perform a decryption process on the encrypted data received from the encryption device via the first transmission line, based on the encryption information received from the management device.

An encryption method of the present disclosure is an encryption method in an encryption system includes a management device, an encryption device, and a decryption device. The encryption device and the decryption device are connected to each other via a first transmission line serving as a physical transmission path, the encryption method includes: transmitting, by the management device, encryption information to the encryption device and the decryption device, the encryption information being related to an encryption scheme to be used in the encryption device and the decryption device; generating, by the encryption device, encrypted data by performing an encryption process on communication data, based on the encryption information received from the management device, and transmitting, by the encryption device, the generated encrypted data to the decryption device via the first transmission line; and performing, by the decryption device, a decryption process on the encrypted data received from the encryption device via the first transmission line, based on the encryption information received from the management device.

An aspect of the present disclosure can be implemented not only as an encryption system including such a characteristic processing unit, but also as a program for causing a computer to execute steps of such a characteristic process, or as a semiconductor integrated circuit that implements a part or all of the encryption system.

### BRIEF DESCRIPTION OF THE DRAWINGS

FIG. 1 is a diagram showing the configuration of an encryption system according to the first embodiment of the present disclosure.

FIG. 2 is an example of a corresponding table held by a management device and a communication device according to the first embodiment of the present disclosure.

FIG. 3 is a diagram showing an example of a sequence of encryption communication in the encryption system according to the first embodiment of the present disclosure.

FIG. 4 is a diagram showing the configuration of an encryption system according to the second embodiment of the present disclosure.

FIG. 5 is a diagram showing the configuration of an encryption system according to the third embodiment of the present disclosure.

FIG. 6 is a diagram showing the configuration of an encryption system according to the fourth embodiment of the present disclosure.

### DETAILED DESCRIPTION

Some techniques for improving security in a network have been developed.

### Problems to be Solved by Present Disclosure

A technique that can further improve security in a network beyond the techniques described in Patent Literature 1 and 2 is desired.

The present disclosure has been made to solve the above problem, and an object of the present disclosure is to provide an encryption system and an encryption method capable of further improving security in a network.

### Advantageous Effects of Present Disclosure

According to the present disclosure, security in a network can be further improved.

### Description of Embodiments of Present Disclosure

First, the contents of embodiments of the present disclosure will be listed and explained.

(1) An encryption system according to an embodiment of the present disclosure includes: a management device, an encryption device; and a decryption device. The encryption device and the decryption device are connected to each other via a first transmission line serving as a physical transmission path, the management device is configured to transmit encryption information to the encryption device and the decryption device, the encryption information being related to an encryption scheme to be used in the encryption device and the decryption device, the encryption device is configured to generate encrypted data by performing an encryption process on communication data, based on the encryption information received from the management device, and to transmit the generated encrypted data to the decryption device via the first transmission line, and the decryption device is configured to perform a decryption process on the encrypted data received from the encryption device via the first transmission line, based on the encryption information received from the management device.

Thus, with the configuration in which the management device transmits the encryption information regarding the encryption scheme to the encryption device and the decryption device, and the encryption device and the decryption device perform the encryption process on the communication data and the decryption process on the encrypted data, based on the encryption information received from the management device, even when the encryption scheme is decrypted by an unauthorized device, for example, the management device can change the encryption scheme and perform the encryption process and the decryption process in accordance with the changed encryption scheme, so that it is possible to achieve robust encryption communication in which the communication data is hardly intercepted by only one successful attack. Thus, the security in the network can be further improved.

(2) In the above (1), the management device may be configured to transmit the encryption information to the encryption device and the decryption device via a second transmission line different from the first transmission line.

With such a configuration, the encryption scheme selected by the management device can be more securely notified to the encryption device and the decryption device.

(3) In the above (1) or (2), the management device, the encryption device, and the decryption device may be configured to hold correspondence information indicating a correspondence between the encryption information and the encryption scheme, the management device may be configured to refer to the correspondence information to transmit the encryption information to the encryption device and the decryption device, the encryption information corresponding to the encryption scheme to be used in the encryption device and the decryption device, the encryption device may be configured to refer to the correspondence information to perform the encryption process on the communication data in accordance with the encryption scheme corresponding to the encryption information received from the management device, and the decryption device may be configured to refer to the correspondence information to perform the decryption process on the encrypted data in accordance with the encryption scheme corresponding to the encryption information received from the management device.

With such a configuration, the encryption scheme selected by the management device can be more securely notified to the encryption device and the decryption device with a simple configuration.

(4) In any one of the above (1) to (3), the management device may be configured to select, in accordance with confidentiality of the communication data, the encryption scheme to be used in the encryption device and the decryption device.

With such a configuration, since an encryption scheme having encryption strength corresponding to the confidentiality of communication data can be used, communication data with high confidentiality can be transmitted more securely.

(5) In any one of the above (1) to (4), the management device may be configured to select, in accordance with real-time performance required for the communication data, the encryption scheme to be used in the encryption device and the decryption device.

With such a configuration, it is possible to use an encryption scheme with a delay amount corresponding to real-time performance required for communication data, and thus it is possible to further reduce a transmission delay in an application requiring real-time performance.

(6) In any one of the above (1) to (5), the encryption system may comprise a plurality of management devices, the encryption device may be configured to perform the encryption process on the communication data in accordance with the encryption scheme identified based on a plurality of pieces of the encryption information received from the respective plurality of management devices, and the decryption device may be configured to perform the decryption process on the encrypted data in accordance with the encryption scheme identified based on a plurality of pieces of the encryption information received from the respective plurality of management devices.

With such a configuration, even when a part of the plurality of management devices is hacked or a part of the plurality of pieces of the encryption information is intercepted, the encryption scheme to be used in the encryption device and the decryption device is not decrypted, and thus the encryption scheme to be used in the encryption device and the decryption device can be more securely notified to the encryption device and the decryption device.

(7) In any one of the above (1) to (6), the first transmission line may be used to form a plurality of logical transmission paths, the management device may be configured to transmit the encryption information to the encryption device and the decryption device, the encryption information indicating a target transmission path, the target transmission path being a target of encryption communication among the plurality of logical transmission paths, the encryption device may be configured to perform the encryption process on the communication data to be transmitted via the target transmission path indicated by the encryption information, and the decryption device may be configured to perform the decryption process on the encrypted data transmitted via the target transmission path indicated by the encryption information.

With such a configuration, for example, a plurality of pieces of the communication data can be transmitted using a plurality of transmission paths, and encryption communication can be performed in a target transmission path among the plurality of transmission paths, and thus the communication data can be made less likely to be intercepted.

(8) An encryption method of the present disclosure is an encryption method in an encryption system includes a management device, an encryption device, and a decryption device. The encryption device and the decryption device are connected to each other via a first transmission line serving as a physical transmission path, the encryption method includes: transmitting, by the management device, encryption information to the encryption device and the decryption device, the encryption information being related to an encryption scheme to be used in the encryption device and the decryption device; generating, by the encryption device, encrypted data by performing an encryption process on communication data, based on the encryption information received from the management device, and transmitting, by the encryption device, the generated encrypted data to the decryption device via the first transmission line; and performing, by the decryption device, a decryption process on the encrypted data received from the encryption device via the first transmission line, based on the encryption information received from the management device.

Thus, with the method in which the management device transmits the encryption information regarding the encryption scheme to the encryption device and the decryption device, and the encryption device and the decryption device perform the encryption process on the communication data and the decryption process on the encrypted data, based on the encryption information received from the management device, even when the encryption scheme is decrypted by an unauthorized device, for example, the management device can change the encryption scheme and perform the encryption process and the decryption process in accordance with the changed encryption scheme, so that it is possible to achieve robust encryption communication in which the communication data is hardly intercepted by only one successful attack. Thus, the security in the network can be further improved.

Hereinafter, embodiments of the present disclosure will be described with reference to the drawings. In the drawings, the same or corresponding parts are denoted by the same reference numerals, and the description thereof will not be repeated. At least a part of the embodiments described below may be arbitrarily combined.

### First Embodiment

### Configuration and Basic Operation

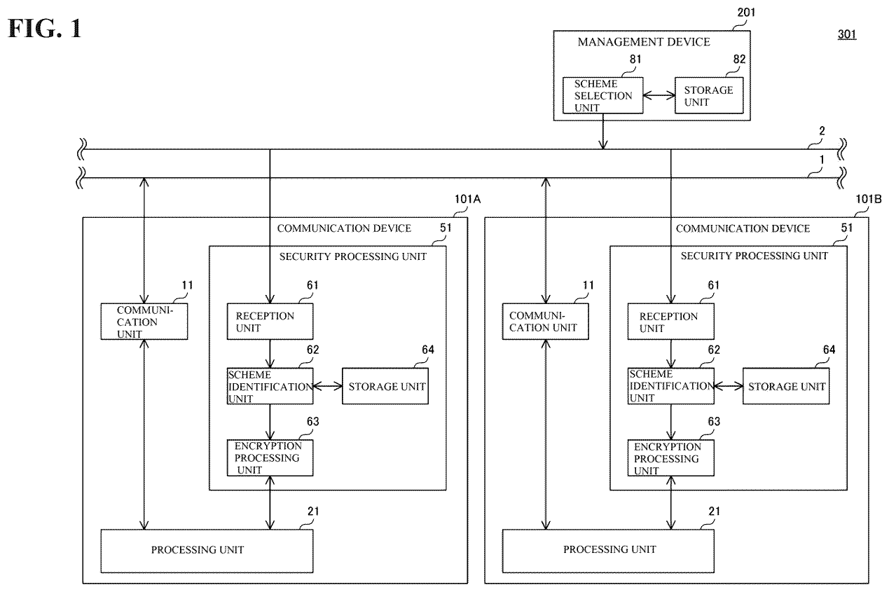

FIG. 1 is a diagram showing the configuration of an encryption system according to the first embodiment of the present disclosure. Referring to FIG. 1, an encryption system 301 includes a management device 201 and a plurality of communication devices 101. In FIG. 1, communication devices 101A and 101B are shown as representative examples of communication device 101. Communication device 101A is an example of an encryption device. Communication device 101B is an example of a decryption device.

For example, encryption system 301 is used for a network in an industrial control system such as a factory and a plant. In this case, communication device 101 is, for example, a PLC (Programmable Logic Controller) for controlling a robot, a sensor, or an actuator.

The plurality of communication devices 101 are connected to each other via a transmission line 1 serving as a physical transmission path. Transmission line 1 is an example of a first transmission line. Transmission line 1 is, for example, a transmission line conforming to the CAN (Controller Area Network) (registered trademark) standard. Transmission line 1 may be a transmission line conforming to the Ethernet (registered trademark) standard, or may be a transmission line for serial communications conforming to a standard such as RS (Recommended Standard)-232C, RS-422A, or RS-485. Communication devices 101A and 101B may be configured to be connected via a wide area network (WAN).

Encryption system 301 may be used in a home network or an in-vehicle network. When encryption system 301 is used in an in-vehicle network, communication device 101 and management device 201 are in-vehicle electronic control units (ECU).

Management device 201 is connected to the plurality of communication devices 101 via a transmission line 2 serving as a physical transmission path. Transmission line 2 is an example of a second transmission line. Transmission line 2 is, for example, a transmission line conforming to the CAN standard. Transmission line 2 may be a transmission line conforming to the Ethernet standard, or may be a transmission line for serial communications conforming to a standard such as RS (Recommended Standard)-232C, RS-422A, or RS-485.

Communication device 101 performs encryption communication via transmission line 1. For example, communication device 101A generates encrypted data by encrypting communication data periodically or non-periodically, and transmits a frame including the generated encrypted data to communication device 101B via transmission line 1. Communication device 101B receives the frame from communication device 101A via transmission line 1, and decrypts the encrypted data included in the received frame.

Note that communication devices 101A and 101B may be configured to perform bidirectional encryption communication. More specifically, communication device 101B periodically or non-periodically transmits a frame including encrypted data to communication device 101A via transmission line 1. Communication device 101A receives the frame from communication device 101B via transmission line 1, and decrypts the encrypted data included in the received frame.

Management device 201 includes a scheme selection unit 81 and a storage unit 82. A part or all of scheme selection unit 81 is implemented by, for example, a processing circuit (circuitry) including one or more processors. Storage unit 82 is, for example, a nonvolatile memory included in the processing circuit.

Communication device 101 includes a communication unit 11, a processing unit 21, and a security processing unit 51. Security processing unit 51 includes a reception unit 61, a scheme identification unit 62, an encryption processing unit 63, and a storage unit 64. Some or all of communication unit 11, processing unit 21, reception unit 61, and scheme identification unit 62 are implemented by, for example, a processing circuit (circuitry) including one or more processors. Encryption processing unit 63 is implemented by, for example, a field-programmable gate array (FPGA). Storage unit 64 is, for example, a nonvolatile memory included in the processing circuit.

Security processing unit 51 may be built in communication device 101, or may be built in an external adapter or connector connected to communication device 101.

Storage unit 64 in communication device 101 stores a cryptographic key used in encryption communication between communication devices 101.

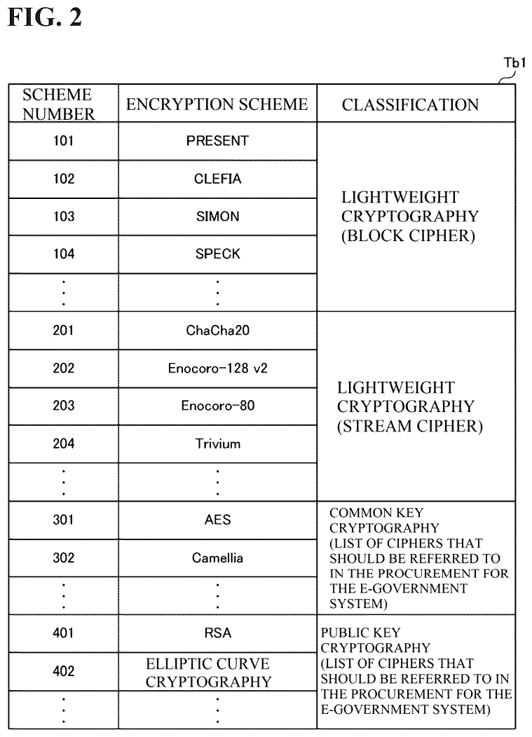

FIG. 2 is an example of a corresponding table held by the management device and the communication device according to a first embodiment of the present disclosure. Referring to FIG. 2, storage unit 82 in management device 201 and storage unit 64 in communication device 101 store a corresponding table Tb1 indicating the correspondence between the scheme number and the encryption scheme used in the encryption communication between communication devices 101. Corresponding table Tb1 is an example of corresponding information.

In corresponding table Tb1, the encryption scheme corresponding to the scheme number “101” is “PRESENT”, the encryption scheme corresponding to the scheme number “102” is “CLEFIA”, the encryption scheme corresponding to the scheme number “103” is “SIMON”, the encryption scheme corresponding to the scheme number “104” is “SPECK”, the encryption scheme corresponding to the scheme number “201” is “ChaCha20”, the encryption scheme corresponding to the scheme number “202” is “Enocoro-128 v2”, the encryption scheme corresponding to the scheme number “203” is “Enocoro-80”, the encryption scheme corresponding to the scheme number “204” is “Trivium”, the encryption scheme corresponding to the scheme number “301” is “AES (Advanced Encryption Standard)”, the encryption scheme corresponding to the scheme number “302” is “Camellia”, the encryption scheme corresponding to the scheme number “401” is “RSA”, and the encryption scheme corresponding to the scheme number “402” is “elliptic curve cryptography”.

PRESENT, CLEFIA, SIMON and SPECK are block ciphers of lightweight cryptography, and the encryption strength is 80 bits or more. PRESENT, CLEFIA, SIMON, and SPECK are generally used for encryption communication, and are fast and low in implementation cost.

ChaCha20, Enocoro-128 v2, Enocoro-80 and Trivium are stream ciphers of lightweight cryptography, with encryption strength of 80 bits or more. ChaCha20, Enocoro-128 v2, Enocoro-80 and Trivium are generally used for encryption communication, and are fast, low in implementation cost and high in real-time performance.

AES and Camellia are common key cryptography listed in the list of ciphers that should be referred to in the procurement for the e-Government system, and the encryption strength is 128 bits or more. AES and Camellia are generally used for encryption communication and have high encryption strength.

RSA and elliptic curve cryptography are public key cryptography listed in the list of ciphers that should be referred to in the procurement for the e-Government system, and the encryption strength is 128 bits or more. RSA and elliptic curve cryptography are generally used for key exchange and electronic signature, have high encryption strength, and do not require management of a secret key of a communication partner.

### Transmission of Encryption Information

Referring again to FIG. 1, management device 201 transmits encryption information to communication devices 101A and 101B, encryption information regarding the encryption scheme to be used in communication devices 101A and 101B.

More specifically, scheme selection unit 81 in management device 201 selects an encryption scheme to be used in the encryption communication between communication devices 101A and 101B.

For example, scheme selection unit 81 selects an encryption scheme according to the type of application that generates communication data transmitted in communication devices 101A and 101B, the operation mode of the industrial control system in which encryption system 301 is used, the confidentiality of communication data transmitted in communication devices 101A and 101B, and the like.

Scheme selection unit 81 refers to corresponding table Tb1 in storage unit 82, and acquires the scheme number corresponding to the selected encryption scheme. Scheme selection unit 81 generates encryption information including the acquired scheme number, and transmits a frame including the generated encryption information to communication devices 101A and 101B via a physically independent transmission line 2 different from transmission line 1 for encryption communication.

In communication devices 101A and 101B, reception unit 61 receives the frame from management device 201 via transmission line 2, and acquires the encryption information from the received frame. Reception unit 61 outputs the acquired encryption information to scheme identification unit 62.

Scheme identification unit 62 receives the encryption information from reception unit 61, refers to corresponding table Tb1 in storage unit 64, and identifies the encryption scheme corresponding to the scheme number indicated by the received encryption information. Scheme identification unit 62 acquires a cryptographic key used in the identified encryption scheme from storage unit 64. Scheme identification unit 62 outputs encryption setting information indicating the identified encryption scheme and the acquired cryptographic key to encryption processing unit 63.

Encryption processing unit 63 performs an encryption process on communication data addressed to other communication device 101 and a decryption process on encrypted data received from other communication device 101 using the cryptographic key indicated by the encryption setting information in accordance with the encryption scheme indicated by the encryption setting information received from scheme identification unit 62.

Scheme selection unit 81 is not limited to the configuration of selecting the above-described standardized encryption scheme, and can select an arbitrary encryption scheme that is not standardized.

### Encryption Process

Communication device 101A generates encrypted data by performing an encryption process on communication data, based on the encryption information received from management device 201, and transmits the generated encrypted data to a communication device 111B via transmission line 1. For example, communication device 101A refers to corresponding table Tb1 to perform the encryption process on the communication data in accordance with the encryption scheme corresponding to the encryption information received from management device 201.

More specifically, processing unit 21 in communication device 101A generates communication data addressed to communication device 101B periodically or non-periodically. Processing unit 21 outputs the generated communication data to encryption processing unit 63.

Encryption processing unit 63 in communication device 101A receives the communication data from processing unit 21 and encrypts the received communication data in accordance with the encryption scheme indicated by the encryption setting information received from scheme identification unit 62. Encryption processing unit 63 outputs encrypted data, which is the encrypted communication data, to processing unit 21.

Processing unit 21 in communication device 101A receives the encrypted data from encryption processing unit 63 and outputs the received encrypted data to communication unit 11.

Communication unit 11 in communication device 101A includes the encrypted data received from processing unit 21 in a frame and transmits the frame to communication device 101B via transmission line 1.

### Decryption Process

Communication device 101B performs a decryption process on the encrypted data received from a communication device 111A via transmission line 1 based on the encryption information received from management device 201. For example, communication device 101B refers to corresponding table Tb1 to perform the decryption process on the encrypted data in accordance with the encryption scheme corresponding to the encryption information received from management device 201.

Communication unit 11 in communication device 101B receives the frame from communication device 101A via transmission line 1, and acquires the encrypted data from the received frame. Communication unit 11 outputs the acquired encrypted data to processing unit 21.

Processing unit 21 in communication device 101B receives the encrypted data from communication unit 11 and outputs the received encrypted data to encryption processing unit 63.

Encryption processing unit 63 in communication device 101B receives the encrypted data from processing unit 21, and decrypts the received encrypted data by using the encryption scheme indicated by the encryption setting information received from scheme identification unit 62, thereby acquiring the communication data. Encryption processing unit 63 outputs the acquired communication data to processing unit 21.

Processing unit 21 in communication device 101B processes the communication data received from encryption processing unit 63.

### Switching of Encryption Scheme

For example, scheme selection unit 81 in management device 201 dynamically switches the encryption scheme to be used in communication devices 101A and 101B. More specifically, scheme selection unit 81 periodically or non-periodically includes the encryption information in a frame and transmits the frame to communication devices 101A and 101B via transmission line 2.

Scheme selection unit 81 further transmits timing information indicating the switching timing of the encryption scheme to communication devices 101A and 101B via transmission line 2. The timing information may be information including an absolute time indicating the switching timing, may be information including a relative time based on the immediately preceding switching timing, or may be a timing signal such as a clock for synchronizing the switching timing.

In communication devices 101A and 101B, reception unit 61 outputs the timing information received from management device 201 via transmission line 2 to scheme identification unit 62.

Scheme identification unit 62 receives the timing information from reception unit 61 and notifies encryption processing unit 63 of the switching timing indicated by the received timing information.

Encryption processing unit 63 switches the encryption scheme at the switching timing notified from scheme identification unit 62.

### Switching Example 1

For example, scheme selection unit 81 periodically switches the encryption scheme at a frequency corresponding to the confidentiality of the communication data transmitted in communication devices 101A and 101B.

As an example, scheme selection unit 81 switches the encryption scheme from PRESENT to CLEFIA and then to SIMON at the switching timing according to a predetermined switching cycle Cc.

More specifically, scheme selection unit 81 transmits encryption information including “102” as the scheme number to communication devices 101A and 101B via transmission line 2 in order to switch the encryption scheme from PRESENT to CLEFIA in a state where the encryption process on communication data and the decryption process on encrypted data are performed in communication devices 101A and 101B in accordance with PRESENT. Scheme selection unit 81 further transmits timing information indicating the switching timing from PRESENT to CLEFIA to communication devices 101A and 101B via transmission line 2.

Thereafter, scheme selection unit 81 transmits encryption information including “103” as the scheme number to communication devices 101A and 101B via transmission line 2 in order to switch the encryption scheme from CLEFIA to SIMON in a state where the encryption process on communication data and the decryption process on encrypted data are performed in communication devices 101A and 101B in accordance with CLEFIA. Scheme selection unit 81 further transmits timing information indicating the switching timing from CLEFIA to SIMON to communication devices 101A and 101B via transmission line 2.

Scheme selection unit 81 may be configured to switch the encryption scheme at random timing instead of periodically switching the encryption scheme. Scheme selection unit 81 may be configured to transmit encryption information including a random number as a scheme number to communication devices 101A and 101B via transmission line 2. Scheme selection unit 81 may be configured to create a switching plan of the encryption scheme and transmit encryption information including a plurality of scheme numbers based on the created switching plan to communication devices 101A and 101B via transmission line 2, or may be configured to transmit timing information indicating a plurality of switching timings based on the switching plan to communication devices 101A and 101B via transmission line 2.

### Switching Example 2

For example, scheme selection unit 81 selects an encryption scheme to be used in communication devices 101A and 101B in accordance with the confidentiality of communication data transmitted in communication devices 101A and 101B.

More specifically, scheme selection unit 81 holds information indicating a confidential communication period in which the communication data with high confidentiality is transmitted in communication devices 101A and 101B in advance. Scheme selection unit 81 selects a public key cryptography such as RSA and elliptic curve cryptography or a common key cryptography such as AES and Camellia, which has higher encryption strength, as an encryption scheme in the confidential communication period.

For example, when the encryption process on communication data and the decryption process on encrypted data are performed in communication devices 101A and 101B in accordance with PRESENT having an encryption strength of 80 bits a predetermined time before the start time of the confidential communication period, scheme selection unit 81 transmits encryption information including “301” as the scheme number to communication devices 101A and 101B via transmission line 2 in order to switch the encryption scheme from PRESENT to AES having an encryption strength of 128 bits. Scheme selection unit 81 further transmits timing information indicating the switching timing from PRESENT to AES to communication devices 101A and 101B via transmission line 2.

### Switching Example 3

For example, scheme selection unit 81 selects an encryption scheme to be used in communication devices 101A and 101B in accordance with the real-time performance required for the communication data transmitted in communication devices 101A and 101B.

More specifically, scheme selection unit 81 holds information indicating a real-time communication period in which communication data requiring high real-time performance is transmitted in communication devices 101A and 101B in advance. Scheme selection unit 81 selects a stream cipher of a lightweight cryptography such as ChaCha20, Enocoro-128 v2, Enocoro-80, and Trivium, which has higher real-time performance, as an encryption scheme in a real-time communication period.

For example, when the encryption process on the communication data and the decryption process on the encrypted data are performed in communication devices 101A and 101B in accordance with PRESENT a predetermined time before the start time of the real-time communication period, scheme selection unit 81 transmits the encryption information including “201” as the scheme number to communication devices 101A and 101B via transmission line 2 in order to switch the encryption scheme from PRESENT to ChaCha20 with high real-time performance. Scheme selection unit 81 further transmits timing information indicating the switching timing from PRESENT to ChaCha20 to communication devices 101A and 101B via transmission line 2.

Scheme selection unit 81 may perform switching of the encryption scheme by combining some or all of the switching examples 1 to 3.

### Flow of Operation

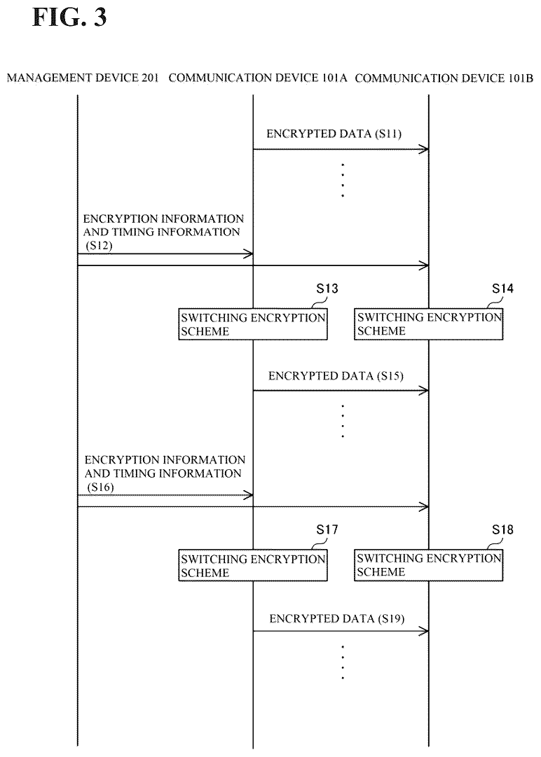

FIG. 3 is a diagram showing an example of a sequence of encryption communication in the encryption system according to a first embodiment of the present disclosure. FIG. 3 shows a sequence of the above-described switching example 1.

Referring to FIG. 3, first, communication device 101A generates encrypted data by encrypting communication data in accordance with PRESENT corresponding to the scheme number “101”, and transmits the generated encrypted data to communication device 101B via transmission line 1 while including the encrypted data in a frame. Communication device 101B decrypts the encrypted data received from communication device 101A in accordance with PRESENT (a step S11).

Next, management device 201 transmits encryption information including “102” as a scheme number and timing information indicating the switching timing from PRESENT to CLEFIA to communication devices 101A and 101B via transmission line 2 in order to switch the encryption scheme at the switching timing according to switching cycle Cc (a step S12).

Next, communication device 101A switches the encryption scheme to CLEFIA corresponding to the scheme number “102” indicated by the encryption information received from management device 201 at the switching timing indicated by the timing information received from management device 201 (a step S13).

Communication device 101B switches the encryption scheme to CLEFIA corresponding to the scheme number “102” indicated by the encryption information received from management device 201 at the switching timing indicated by the timing information received from management device 201 (a step S14).

Next, communication device 101A generates encrypted data by encrypting the communication data in accordance with CLEFIA, and transmits the generated encrypted data to communication device 101B via transmission line 1 while including the encrypted data in a frame. Communication device 101B decrypts the encrypted data received from communication device 101A in accordance with CLEFIA (a step S15).

Next, management device 201 transmits encryption information including “103” as a scheme number and timing information indicating the switching timing from CLEFIA to SIMON to communication devices 101A and 101B via transmission line 2 in order to switch the encryption scheme at the switching timing according to switching cycle Cc (a step S16).

Next, communication device 101A switches the encryption scheme to SIMON corresponding to the scheme number “103” indicated by the encryption information received from management device 201 at the switching timing indicated by the timing information received from management device 201 (a step S17).

Communication device 101B switches the encryption scheme to SIMON corresponding to the scheme number “103” indicated by the encryption information received from management device 201 at the switching timing indicated by the timing information received from management device 201 (a step S18).

Next, communication device 101A generates encrypted data by encrypting the communication data in accordance with SIMON, and transmits the generated encrypted data to communication device 101B via transmission line 1 while including the encrypted data in a frame. Communication device 101B decrypts the encrypted data received from communication device 101A in accordance with SIMON (a step S19).

Management device 201 may create a switching plan for switching the encryption scheme at the switching timing according to switching cycle Cc, and in step S12, based on the created switching plan, may transmit the encryption information including “102” and “103” as the scheme numbers and the timing information indicating the switching timing from PRESENT to CLEFIA and the switching timing from CLEFIA to SIMON to communication devices 101A and 101B via transmission line 2. In this case, management device 201 does not perform the process of step S16.

In encryption system 301 according to the embodiment of the present disclosure, storage unit 82 in management device 201 and storage unit 64 in communication device 101 are configured to store corresponding table Tb1 indicating the correspondence between the scheme number and the encryption scheme used in the encryption communication between communication devices 101, but the present disclosure is not limited to this. Storage unit 82 and storage unit 64 may be configured not to store corresponding table Tb1. In this case, scheme selection unit 81 in management device 201 transmits encryption information including the algorithm itself of the selected encryption scheme to communication devices 101A and 101B instead of transmitting encryption information including the scheme number to communication devices 101A and 101B.

In encryption system 301 according to the embodiment of the present disclosure, management device 201 is configured to connect to communication device 101 via transmission line 2, but the present disclosure is not limited to this configuration. Management device 201 may be configured not to be connected to communication device 101 via transmission line 2. In this case, for example, scheme selection unit 81 in management device 201 transmits a frame including encryption information to communication devices 101A and 101B by wireless communication.

Further, in encryption system 301 according to the embodiment of the present disclosure, scheme selection unit 81 in management device 201 is configured to transmit the timing information to communication devices 101A and 101B via transmission line 2, but the present disclosure is not limited to this. Scheme selection unit 81 may be configured to transmit the timing information to communication device 101A via transmission line 2, but not to transmit the timing information to communication device 101B. In this case, encryption processing unit 63 in communication device 101A switches the encryption scheme at the switching timing indicated by the timing information received by reception unit 61. Further, before switching the encryption scheme, encryption processing unit 63 includes information indicating that the encryption scheme is switched in the communication data received from processing unit 21, and outputs encrypted data generated by encrypting the communication data including the information to processing unit 21. Processing unit 21 in communication device 101A outputs the encrypted data received from encryption processing unit 63 to communication device 101B via communication unit 11 and transmission line 1.

A technique capable of further improving security in a network is desired. In particular, when communication is performed using a transmission path whose security is not guaranteed, a communication technique for securely transmitting secret information is extremely important.

In the conventional encryption communication technology, the encryption scheme is often fixed. Thus, when the encryption is decrypted by an unauthorized device, all communication data transmitted thereafter may be intercepted by the unauthorized device. In addition, the technology described in Patent literature 1 has only one transmission path used to form a virtual private network (VPN), which has low security strength. In addition, the technique described in Patent literature 2 is a technique for distributing a common key by using photons, and thus the implementation cost is high.

In contrast, in encryption system 301 according to the first embodiment of the present disclosure, management device 201 transmits encryption information to communication devices 101A and 101B, encryption information regarding the encryption scheme to be used in communication devices 101A and 101B. Communication device 101A generates encrypted data by performing an encryption process on communication data, based on the encryption information received from management device 201. Communication device 101B performs a decryption process on the encrypted data based on the encryption information received from management device 201.

Thus, with the configuration in which management device 201 transmits the encryption information regarding the encryption scheme to communication devices 101A and 101B, and communication devices 101A and 101B perform the encryption process on the communication data and the decryption process on the encrypted data based on the encryption information received from management device 201, even when the encryption scheme is decrypted by an unauthorized device, for example, management device 201 can change the encryption scheme and perform the encryption process and the decryption process in accordance with the changed encryption scheme, so that it is possible to achieve robust encryption communication in which the communication data is hardly intercepted by only one successful attack. In the conventional configuration in which the cryptographic key is switched between communication devices 101A and 101B, when the encryption communication between communication devices 101A and 101B is decrypted by an attack, even when the cryptographic key is switched, the cryptographic key after the switching is also easily decrypted. In contrast, in the above-described configuration, even when the encryption communication between communication devices 101A and 101B is decrypted by an attack, it is not easy to decrypt the changed encryption scheme by changing the encryption scheme in management device 201. Thus, the security in the network can be further improved.

Next, another embodiment of the present disclosure will be described with reference to the drawing. In the drawing, the same or corresponding parts are denoted by the same reference numerals, and the description thereof will not be repeated.

### Second Embodiment

The present embodiment relates to an encryption system 302 in which communication data and encryption information are multiplexed in transmission line 1, as compared with encryption system 301 according to the first embodiment. Encryption system 302 according to the second embodiment is the same as encryption system 301 according to the first embodiment except for the contents described below.

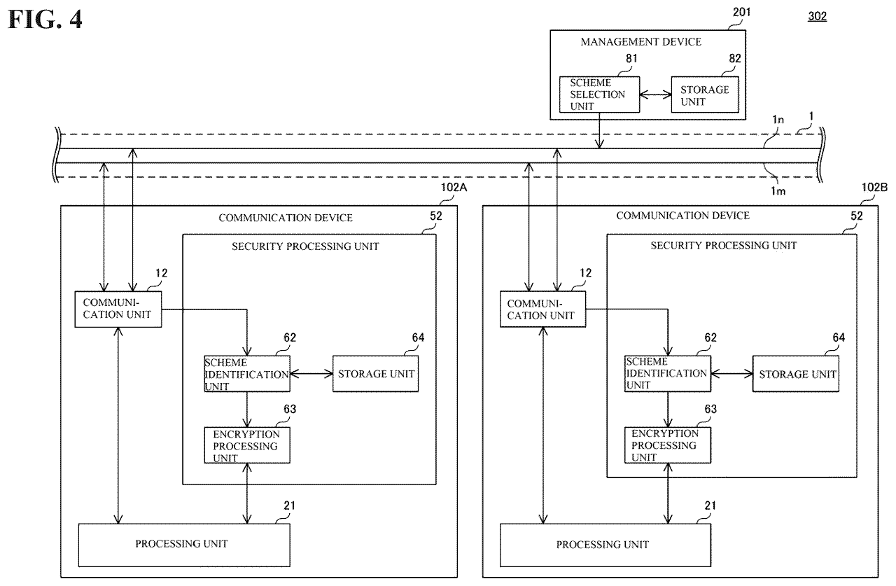

FIG. 4 is a diagram showing the configuration of an encryption system according to the second embodiment of the present disclosure. Referring to FIG. 4, encryption system 302 includes a communication device 102 instead of communication device 101 and management device 201 is connected to the plurality of communication devices 102 via transmission line 1, as compared with encryption system 301. In FIG. 4, communication devices 102A and 102B are shown as representative examples of communication device 102. Communication device 102A is an example of an encryption device. Communication device 102B is an example of a decryption device. In encryption system 302, transmission line 1 is used to form logical transmission paths 1n and 1m different from each other. That is, two logical paths are formed in physical transmission line 1. Communication device 101 performs encryption communication via transmission path 1m.

Communication device 102 includes a communication unit 12 instead of communication unit 11 and a security processing unit 52 instead of security processing unit 51, as compared with communication device 101. Security processing unit 52 does not include reception unit 61, as compared with security processing unit 51.

Scheme selection unit 81 transmits a frame including the encryption information to communication devices 102A and 102B via transmission line 1.

For example, scheme selection unit 81 transmits the frame including the encryption information to communication devices 102A and 102B via transmission path 1n that is different from transmission path 1m for the encryption communication and is logically independent. More specifically, scheme selection unit 81 transmits the encryption information to communication devices 102A and 102B by performing frequency division multiplexing, time division multiplexing, or code division multiplexing on the encryption information on transmission line 1 through which the communication data is transmitted.

Further, for example, scheme selection unit 81 further transmits the timing information to communication devices 102A and 102B via transmission path 1n by performing frequency division multiplexing, time division multiplexing, or code division multiplexing on the timing information in transmission line 1.

In communication devices 102A and 102B, communication unit 12 receives the frame from management device 201 via transmission path In, and acquires the encryption information from the received frame. Communication unit 12 outputs the acquired encryption information to scheme identification unit 62. Communication unit 12 outputs the timing information received from management device 201 via transmission path In to scheme identification unit 62.

Scheme identification unit 62 receives the encryption information from communication unit 12, identifies the encryption scheme with reference to corresponding table Tb1 in storage unit 64, and acquires the cryptographic key used in the identified encryption scheme from storage unit 64. Scheme identification unit 62 outputs encryption setting information indicating the identified encryption scheme and the acquired cryptographic key to encryption processing unit 63. Scheme identification unit 62 notifies encryption processing unit 63 of the switching timing indicated by the timing information received from communication unit 12.

Encryption processing unit 63 switches the encryption scheme in accordance with the encryption setting information received from scheme identification unit 62 at the switching timing notified from scheme identification unit 62.

Processing unit 21 in communication device 102A periodically or non-periodically generates communication data addressed to communication device 102B and outputs the generated communication data to encryption processing unit 63.

Encryption processing unit 63 in communication device 102A generates encrypted data by encrypting the communication data received from processing unit 21, and outputs the generated encrypted data to processing unit 21.

Processing unit 21 in communication device 102A receives the encrypted data from encryption processing unit 63 and outputs the received encrypted data to communication unit 12.

Communication unit 12 in communication device 102A includes the encrypted data received from processing unit 21 in a frame and transmits the frame to communication device 102B via transmission path 1m.

Communication unit 12 in communication device 102B receives the frame from communication device 102A via transmission path 1m, acquires the encrypted data from the received frame, and outputs the acquired encrypted data to processing unit 21.

Processing unit 21 in communication device 102B receives the encrypted data from communication unit 12 and outputs the received encrypted data to encryption processing unit 63.

Encryption processing unit 63 in communication device 102B receives the encrypted data from processing unit 21, acquires the communication data by decrypting the received encrypted data, and outputs the acquired communication data to processing unit 21.

Processing unit 21 in communication device 102B processes the communication data received from encryption processing unit 63.

Next, another embodiment of the present disclosure will be described with reference to the drawing. In the drawing, the same or corresponding parts are denoted by the same reference numerals, and the description thereof will not be repeated.

### Third Embodiment

The present embodiment relates to an encryption system 303 including a plurality of management devices 202, as compared with encryption system 301 according to the first embodiment. Encryption system 303 according to the third embodiment is the same as encryption system 301 according to the first embodiment except for the contents described below.

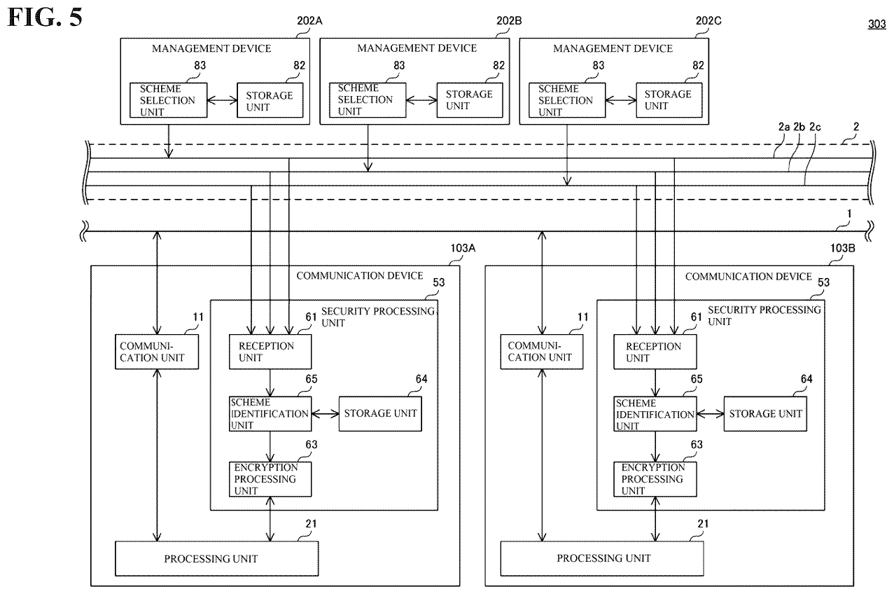

FIG. 5 is a diagram showing the configuration of an encryption system according to the third embodiment of the present disclosure. Referring to FIG. 5, encryption system 303 includes a communication device 103 instead of communication device 101 and management devices 202A, 202B, and 202C, which are management devices 202, instead of management device 201, as compared with encryption system 301. In FIG. 5, communication devices 103A and 103B are shown as representative examples of communication device 103. Communication device 103A is an example of an encryption device. Communication device 103B is an example of a decryption device. Encryption system 303 may be configured to include two or four or more management devices 202. In encryption system 303, transmission line 2 is used to form logical transmission paths 2a, 2b, and 2c different from each other. That is, three logical paths are formed in physical transmission line 2.

Communication device 103 includes a security processing unit 53 instead of security processing unit 51, as compared with communication device 101. Security processing unit 53 includes a scheme identification unit 65 instead of scheme identification unit 62, as compared with security processing unit 51.

Management devices 202A, 202B, and 202C are connected to the plurality of communication devices 101 via transmission line 2. Management device 202 includes a scheme selection unit 83 instead of scheme selection unit 81, as compared with management device 201.

Scheme selection unit 83 in each of management devices 202A, 202B, and 202C selects an encryption scheme to be used in the encryption communication between communication devices 103A and 103B. Each scheme selection unit 83 refers to corresponding table Tb1 in storage unit 82 and acquires the scheme number corresponding to the selected encryption scheme.

For example, scheme selection unit 83 in management device 202A generates an encryption information C1 including the value of the first digit of the acquired scheme number, and transmits a frame including generated encryption information C1 to communication devices 103A and 103B via transmission line 2.

Further, for example, scheme selection unit 83 in management device 202B generates an encryption information C2 including the value of the second digit of the acquired scheme number, and transmits a frame including generated encryption information C2 to communication devices 103A and 103B via transmission line 2.

Further, for example, scheme selection unit 83 in management device 202C generates an encryption information C3 including the value of the third digit of the acquired scheme number, and transmits a frame including generated encryption information C3 to communication devices 103A and 103B via transmission line 2.

As an example, scheme selection unit 83 in management device 202A transmits a frame including encryption information C2 to communication devices 103A and 103B via transmission path 2a. Scheme selection unit 83 in management device 202B transmits the frame including encryption information C2 to communication devices 103A and 103B via transmission path 2b which is different from transmission path 2a for encryption information C1 and is logically independent. Scheme selection unit 83 in management device 202C transmits the frame including encryption information C3 to communication devices 103A and 103B via transmission path 2c which is different from transmission path 2b for encryption information C1 and transmission path 2b for encryption information C2 and is logically independent. That is, management devices 202A, 202B, and 202C transmit encryption information C1, C2, and C3 to communication devices 102A and 102B by performing frequency division multiplexing, time division multiplexing, or code division multiplexing on encryption information C1, C2, and C3 in transmission line 2.

Communication device 103A performs the encryption process on communication data in accordance with an encryption scheme identified based on a plurality of pieces of the encryption information received from the respective plurality of management devices 202. Communication device 103B performs the decryption process on encrypted data in accordance with an encryption scheme identified based on a plurality of pieces of encryption information received from the respective plurality of management devices 202.

More specifically, in communication devices 103A and 103B, reception unit 61 receives the frames from management devices 202A, 202B, and 202C respectively via transmission line 2, and acquires encryption information C1, C2, and C3 from the received frames. Reception unit 61 outputs acquired encryption information C1, C2, and C3 to scheme identification unit 65.

Scheme identification unit 65 receives encryption information C1, C2, and C3 from reception unit 61, and acquires a scheme number by combining the value indicated by encryption information C1, the value indicated by encryption information C2, and the value indicated by encryption information C3. Then, scheme identification unit 65 refers to corresponding table Tb1 in storage unit 64 to identify the encryption scheme corresponding to the obtained scheme number. Scheme identification unit 65 acquires the cryptographic key used in the identified encryption scheme from storage unit 64. Scheme identification unit 65 outputs encryption setting information indicating the identified encryption scheme and the acquired cryptographic key to encryption processing unit 63.

Encryption processing unit 63 in communication device 103A performs the encryption process on the communication data addressed to communication device 103B using the cryptographic key indicated by the encryption setting information in accordance with the encryption scheme indicated by the encryption setting information received from scheme identification unit 65. Encryption processing unit 63 in communication device 103B performs the decryption process on the encrypted data received from communication device 103A using the cryptographic key indicated by the encryption setting information in accordance with the encryption scheme indicated by the encryption setting information received from scheme identification unit 65.

In encryption system 303 according to the embodiment of the present disclosure, management devices 202A, 202B, and 202C are configured to connect to the plurality of communication devices 101 via transmission line 2, but the present disclosure is not limited to this configuration. Management devices 202A, 202B, and 202C may be configured to be connected to the plurality of communication devices 101 via transmission lines physically different from each other. In this case, scheme selection unit 83 in management device 202B transmits the frame including encryption information C2 to communication devices 103A and 103B via a physically independent transmission line different from the transmission line for encryption information C1. Scheme selection unit 83 in management device 202C transmits the frame including encryption information C3 to communication devices 103A and 103B via a physically independent transmission line different from the transmission line for encryption information Cl and the transmission line for encryption information C2.

As described above, in encryption system 303 according to the embodiment of the present disclosure, communication device 103A performs the encryption process on the communication data in accordance with the encryption scheme identified based on encryption information C1, C2, and C3 received from management devices 202A, 202B, and 202C, respectively. Communication device 103B performs the decryption process on the encrypted data in accordance with the encryption scheme identified based on encryption information C1, C2, and C3 received from management devices 202A, 202B, and 202C, respectively.

In this case, in order to acquire the encryption scheme selected by management devices 202A, 202B, and 202C, it is necessary to acquire all encryption information C1, C2, and C3 transmitted by management devices 202A, 202B, and 202C. In order for an attacker to identify the encryption scheme used in communication devices 103A and 103B, the attacker needs to hack all management devices 202A, 202B, and 202C to acquire encryption information C1, C2, and C3 or to intercept encryption information C1, C2, and C3 in transmission line 2. Thus, even when some management devices 202A, 202B, and 202C is hacked or some encryption information C1, C2, and C3 is intercepted, the encryption scheme to be used in communication devices 103A and 103B is not decrypted, and thus security can be further improved.

Next, another embodiment of the present disclosure will be described with reference to the drawing. In the drawing, the same or corresponding parts are denoted by the same reference numerals, and the description thereof will not be repeated.

### Fourth Embodiment

The present embodiment relates to an encryption system 304 in which encryption communication is performed via a plurality of transmission paths, as compared with encryption system 301 according to the first embodiment. Encryption system 304 according to the fourth embodiment is the same as encryption system 301 according to the first embodiment except for the contents described below.

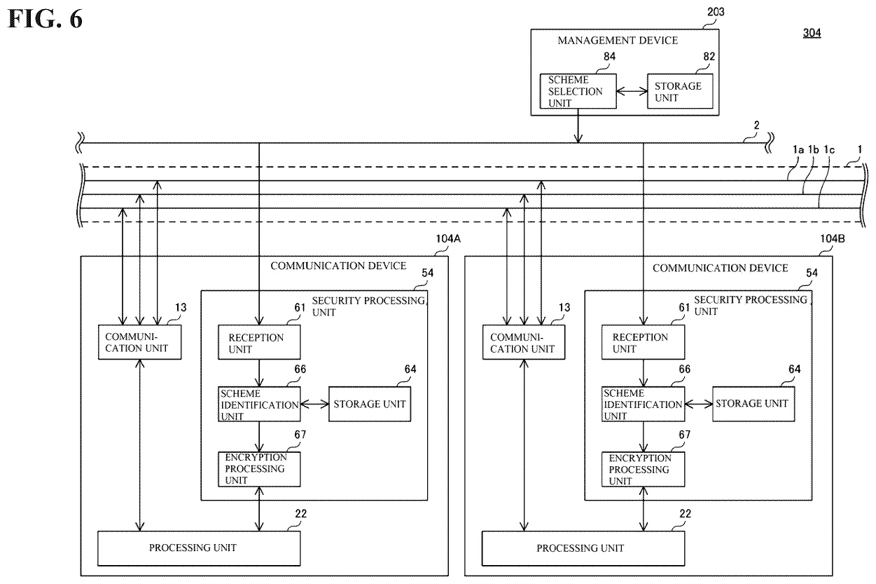

FIG. 6 is a diagram showing the configuration of an encryption system according to the fourth embodiment of the present disclosure. Referring to FIG. 6, encryption system 304 includes a communication device 104 instead of communication device 101 and a management device 203 instead of management device 201, as compared with encryption system 301. In FIG. 6, communication devices 104A and 104B are shown as representative examples of communication device 104. Communication device 104A is an example of an encryption device. Communication device 104B is an example of a decryption device. In encryption system 304, transmission line 1 is used to form logical transmission paths 1a, 1b, and 1c different from each other. That is, three logical paths are formed in physical transmission line 1.

Communication device 104 includes a communication unit 13 instead of communication unit 11, a processing unit 22 instead of processing unit 21, and a security processing unit 54 instead of security processing unit 51, as compared with communication device 101. Security processing unit 54 includes a scheme identification unit 66 instead of scheme identification unit 62 and an encryption processing unit 67 instead of encryption processing unit 63, as compared with security processing unit 51.

Management device 203 includes a scheme selection unit 84 instead of scheme selection unit 81, as compared with management device 201.

Communication device 104 transmits the plurality of pieces of the divided communication data via transmission paths 1a, 1b, and 1c that are logically independent of each other.

For example, in encryption system 304, the communication setting contents such as the connection order of communication data in transmission paths 1a, 1b, and 1c are determined in advance by management device 203.

Communication devices 104A and 104B acquire communication setting information indicating communication setting contents determined by management device 203 in advance. Communication device 104A transmits the plurality of pieces of the divided communication data to communication device 104B via transmission paths 1a, 1b, and 1c in accordance with the connection order indicated by the communication setting information. Communication device 104B connects a plurality of pieces of the communication data received via transmission paths 1a, 1b, and 1c in accordance with the connection order indicated by the communication setting information.

Scheme selection unit 84 in management device 203 selects a target transmission path, which is a transmission path being a target of encryption communication among transmission paths 1a, 1b, and 1c, and an encryption scheme. For example, scheme selection unit 84 selects transmission paths la and 1b as the target transmission paths. Scheme selection unit 84 refers to corresponding table Tb1 in storage unit 82, acquires the scheme number corresponding to the selected encryption scheme, generates encryption information including the acquired scheme number and the selected target transmission path, and transmits a frame including the generated encryption information to communication devices 104A and 104B via transmission line 2.

In communication devices 101A and 101B, reception unit 61 receives the frame from management device 201 via transmission line 2, and acquires the encryption information from the received frame. Reception unit 61 outputs the acquired encryption information to scheme identification unit 66.

Scheme identification unit 66 receives the encryption information from reception unit 61, refers to corresponding table Tb1 in storage unit 64, identifies the encryption scheme corresponding to the scheme number indicated by the received encryption information, and acquires the cryptographic key used in the identified encryption scheme from storage unit 64. Scheme identification unit 66 outputs encryption setting information indicating the target transmission path indicated by the encryption information, the identified encryption scheme, and the acquired cryptographic key to encryption processing unit 67.

Encryption processing unit 67 performs an encryption process on communication data addressed to other communication device 104 and a decryption process on encrypted data received from other communication device 104 using the cryptographic key indicated by the encryption setting information in accordance with the encryption scheme indicated by the encryption setting information received from scheme identification unit 66.

For example, communication device 104A performs an encryption process on communication data Da and Db to be transmitted via the target transmission path indicated by the encryption information.

More specifically, processing unit 22 in communication device 104A generates communication data Da to be transmitted to communication device 101B via transmission path 1a, communication data Db to be transmitted to communication device 101B via transmission path 1b, and a communication data Dc to be transmitted to communication device 101B via transmission path 1c, and outputs generated communication data Da, Db, and Dc to encryption processing unit 67.

Encryption processing unit 67 in communication device 104A receives communication data Da, Db, and Dc from processing unit 22, encrypts communication data Da and Db in accordance with the encryption scheme indicated by the encryption setting information in accordance with the connection order indicated by the communication setting information and the target transmission path indicated by the encryption setting information, and outputs encrypted data Dax and Dbx which are encrypted communication data Da and Db to processing unit 22. Encryption processing unit 67 outputs communication data Dc to processing unit 22 without encryption in accordance with the target transmission path indicated by the encryption setting information.

Processing unit 22 in communication device 104A receives encrypted data Dax and Dbx and unencrypted communication data Dc from encryption processing unit 67, and outputs the received encrypted data Dax and Dbx and communication data Dc to communication unit 13.

Communication unit 13 in communication device 104A includes encrypted data Dax and Dbx and communication data Dc received from processing unit 22 in the frame and transmits the frame to communication device 104B via transmission line 1. More specifically, communication unit 13 transmits received encrypted data Dax and Dbx and communication data Dc to communication device 104B via transmission paths 1a, 1b, and 1c, respectively.

For example, communication device 104B performs a decryption process on encrypted data Dax and Dbx to be transmitted via the target transmission path indicated by the encryption information.

More specifically, communication unit 13 in communication device 104B receives the frame from communication device 104A via transmission line 1, and acquires encrypted data Dax and Dbx and communication data Dc from the received frame. Communication unit 13 outputs acquired encrypted data Dax and Dbx and communication data Dc to processing unit 22.

Processing unit 22 in communication device 104B receives encrypted data Dax and Dbx and communication data Dc from communication unit 13, and outputs the received encrypted data Dax and Dbx and communication data Dc to encryption processing unit 67.

Encryption processing unit 67 in communication device 104B receives encrypted data Dax and Dbx and communication data Dc from processing unit 22, decrypts encrypted data Dax and Dbx using the encryption scheme indicated by the encryption setting information in accordance with the connection order indicated by the communication setting information and the target transmission path indicated by the encryption setting information to acquire communication data Da and Db, and outputs acquired communication data Da and Db to processing unit 22. Encryption processing unit 67 outputs communication data Dc to processing unit 22 without decryption communication data Dc in accordance with the target transmission path indicated by the encryption setting information.

Processing unit 22 in communication device 104B connects communication data Da, Db, and Dc received from encryption processing unit 67 in accordance with the transmission order indicated by the encryption setting information, and processes connected communication data Da, Db, and Dc.

The above embodiments should be considered as illustrative and not restrictive in all respects. The scope of the present invention is defined by the appended claims rather than the foregoing description, and is intended to include all modifications within the scope and meaning equivalent to the appended claims.

Each process (each function) of the above embodiments is implemented by a processing circuit (circuitry) including one or more processors. The processing circuit may be configured by an integrated circuit or the like in which one or more memories, various analog circuits, and various digital circuits are combined in addition to the one or more processors. The one or more memories store a program (instruction) for causing the one or more processors to execute each of the above processes. The one or more processors may execute the processes in accordance with the program read from the one or more memories, or may execute the processes in accordance with a logic circuit designed in advance to execute each of the above processes. The processor may be any of various processors suitable for control of a computer, such as a central processing unit (CPU), a graphics processing unit (GPU), a digital signal processor (DSP), a field programmable gate array (FPGA), and an application specific integrated circuit (ASIC). The plurality of processors physically separated from each other may execute the processes in cooperation with each other. For example, the processors mounted on a plurality of physically separated computers may execute the processes in cooperation with each other via a network such as a local area network (LAN), a wide area network (WAN), or the Internet. The program may be installed in the memory from an external server device or the like via the network, or may be distributed in a state of being stored in a recording medium such as a compact disc read only memory (CD-ROM), a digital versatile disk read only memory (DVD-ROM), or a semiconductor memory and installed in the memory from the recording medium.

The above description includes the features appended below.

### Appendix 1

An encryption system comprising:
a management device;
an encryption device; and
a decryption device, wherein
the encryption device and the decryption device are connected to each other via a first transmission line serving as a physical transmission path,
the management device is configured to transmit encryption information to the encryption device and the decryption device, the encryption information being related to an encryption scheme to be used in the encryption device and the decryption device,
the encryption device is configured to generate encrypted data by performing an encryption process on communication data, based on the encryption information received from the management device, and to transmit the generated encrypted data to the decryption device via the first transmission line,
the decryption device is configured to perform a decryption process on the encrypted data received from the encryption device via the first transmission line, based on the encryption information received from the management device, and
the management device is configured to switch the encryption scheme to be used in the encryption device and the decryption device and to further transmit timing information to the encryption device and the decryption device, the timing information indicating a timing for switching the encryption scheme.

### REFERENCE SIGNS LIST

1 transmission line (first transmission line)
2 transmission line (second transmission line)
1a, 1b, 1c, 1m, 1n, 2a, 2b, 2c transmission path
11, 12, 13 communication unit
21, 22 processing unit
51, 52, 53, 54 security processing unit
61 reception unit
62, 65, 66 scheme identification unit
63, 67 encryption processing unit
64 storage unit
81, 83, 84 scheme selection unit
82 storage unit
101, 102, 103, 104 communication device
101A, 102A, 103A, 104A communication device (encryption device)
101B, 102B, 103B, 104B communication device (decryption device)
201, 202, 202A, 202B, 202C, 203 management device
301, 302, 303, 304 encryption system
Tb1 corresponding table (corresponding information)

1. An encryption system comprising:
a management device;
an encryption device; and
a decryption device, wherein
the encryption device and the decryption device are connected to each other via a first transmission line serving as a physical transmission path,
the management device is configured to transmit encryption information to the encryption device and the decryption device, the encryption information being related to an encryption scheme to be used in the encryption device and the decryption device,
the encryption device is configured to generate encrypted data by performing an encryption process on communication data, based on the encryption information received from the management device, and to transmit the generated encrypted data to the decryption device via the first transmission line, and
the decryption device is configured to perform a decryption process on the encrypted data received from the encryption device via the first transmission line, based on the encryption information received from the management device.

2. The encryption system according to claim 1, wherein the management device is configured to transmit the encryption information to the encryption device and the decryption device via a second transmission line different from the first transmission line.

3. The encryption system according to claim 1, wherein
the management device, the encryption device, and the decryption device are configured to hold correspondence information indicating a correspondence between the
encryption information and the encryption scheme,
the management device is configured to refer to the correspondence information to transmit the encryption information to the encryption device and the decryption device, the encryption information corresponding to the encryption scheme to be used in the encryption device and the decryption device,
the encryption device is configured to refer to the correspondence information to perform the encryption process on the communication data in accordance with the encryption scheme corresponding to the encryption information received from the management device, and
the decryption device is configured to refer to the correspondence information to perform the decryption process on the encrypted data in accordance with the encryption scheme corresponding to the encryption information received from the management device.

4. The encryption system according to claim 1, wherein the management device is configured to select, in accordance with confidentiality of the communication data, the encryption scheme to be used in the encryption device and the decryption device.

5. The encryption system according to claim 1, wherein the management device is configured to select, in accordance with real-time performance required for the communication data, the encryption scheme to be used in the encryption device and the decryption device.

6. The encryption system according to claim 1, wherein
the management device comprises a plurality of management devices,
the encryption device is configured to perform the encryption process on the communication data in accordance with the encryption scheme identified based on a plurality of pieces of the encryption information received from the respective plurality of management devices, and
the decryption device is configured to perform the decryption process on the encrypted data in accordance with the encryption scheme identified based on a plurality of pieces of the encryption information received from the respective plurality of management devices.

7. The encryption system according to claim 1, wherein
the first transmission line is used to form a plurality of logical transmission paths,
the management device is configured to transmit the encryption information to the encryption device and the decryption device, the encryption information indicating a target transmission path, the target transmission path being a target of encryption communication among the plurality of logical transmission paths,
the communication data includes first communication data and second communication data,
the encryption device is configured to generate the encrypted data by performing an encryption process on the first communication data to be transmitted via the target transmission path indicated by the encryption information, to transmit the encrypted data to the decryption device via the target transmission path, and to transmit the second communication data to the decryption device via the logical transmission path different from the target transmission path, and
the decryption device is configured to acquire the first communication data by preforming a decryption process on the encrypted data transmitted via the target transmission path indicated by the encryption information, and to connect the first communication data and the second communication data transmitted via the logical transmission path different from the target transmission path.

8. (canceled)

9. The encryption system according to claim 1, wherein the management device switches the encryption scheme at a frequency corresponding to the confidentiality of the communication data by transmitting the encryption information to the encryption device and the decryption device.

10. The encryption system according to claim 2, wherein
the management device, the encryption device, and the decryption device are configured to hold correspondence information indicating a correspondence between the encryption information and the encryption scheme,
the management device is configured to refer to the correspondence information to transmit the encryption information to the encryption device and the decryption device, the encryption information corresponding to the encryption scheme to be used in the encryption device and the decryption device,
the encryption device is configured to refer to the correspondence information to perform the encryption process on the communication data in accordance with the encryption scheme corresponding to the encryption information received from the management device, and
the decryption device is configured to refer to the correspondence information to perform the decryption process on the encrypted data in accordance with the encryption scheme corresponding to the encryption information received from the management device.

11. The encryption system according to claim 2, wherein the management device is configured to select, in accordance with confidentiality of the communication data, the encryption scheme to be used in the encryption device and the decryption device.

12. The encryption system according to claim 3, wherein the management device is configured to select, in accordance with confidentiality of the communication data, the encryption scheme to be used in the encryption device and the decryption device.

13. The encryption system according to claim 2, wherein the management device is configured to select, in accordance with real-time performance required for the communication data, the encryption scheme to be used in the encryption device and the decryption device.

14. The encryption system according to claim 3, wherein the management device is configured to select, in accordance with real-time performance required for the communication data, the encryption scheme to be used in the encryption device and the decryption device.

15. The encryption system according to claim 4, wherein the management device is configured to select, in accordance with real-time performance required for the communication data, the encryption scheme to be used in the encryption device and the decryption device.

16. The encryption system according to claim 2, wherein
the management device comprises a plurality of management devices,
the encryption device is configured to perform the encryption process on the communication data in accordance with the encryption scheme identified based on a plurality of pieces of the encryption information received from the respective plurality of management devices, and
the decryption device is configured to perform the decryption process on the encrypted data in accordance with the encryption scheme identified based on a plurality of pieces of the encryption information received from the respective plurality of management devices.

17. The encryption system according to claim 3, wherein
the management device comprises a plurality of management devices,
the encryption device is configured to perform the encryption process on the communication data in accordance with the encryption scheme identified based on a plurality of pieces of the encryption information received from the respective plurality of management devices, and
the decryption device is configured to perform the decryption process on the encrypted data in accordance with the encryption scheme identified based on a plurality of pieces of the encryption information received from the respective plurality of management devices.

18. The encryption system according to claim 4, wherein
the management device comprises a plurality of management devices,
the encryption device is configured to perform the encryption process on the communication data in accordance with the encryption scheme identified based on a plurality of pieces of the encryption information received from the respective plurality of management devices, and
the decryption device is configured to perform the decryption process on the encrypted data in accordance with the encryption scheme identified based on a plurality of pieces of the encryption information received from the respective plurality of management devices.

19. The encryption system according to claim 5, wherein
the management device comprises a plurality of management devices,
the encryption device is configured to perform the encryption process on the communication data in accordance with the encryption scheme identified based on a plurality of pieces of the encryption information received from the respective plurality of management devices, and
the decryption device is configured to perform the decryption process on the encrypted data in accordance with the encryption scheme identified based on a plurality of pieces of the encryption information received from the respective plurality of management devices.

20. The encryption system according to claim 2, wherein
the first transmission line is used to form a plurality of logical transmission paths,
the management device is configured to transmit the encryption information to the encryption device and the decryption device, the encryption information indicating a target transmission path, the target transmission path being a target of encryption communication among the plurality of logical transmission paths,
the communication data includes first communication data and second communication data,
the encryption device is configured to generate the encrypted data by performing an encryption process on the first communication data to be transmitted via the target transmission path indicated by the encryption information, to transmit the encrypted data to the decryption device via the target transmission path, and to transmit the second communication data to the decryption device via the logical transmission path different from the target transmission path, and
the decryption device is configured to acquire the first communication data by preforming a decryption process on the encrypted data transmitted via the target transmission path indicated by the encryption information, and to connect the first communication data and the second communication data transmitted via the logical transmission path different from the target transmission path.

21. An encryption method in an encryption system comprising a management device, an encryption device, and a decryption device, wherein
the encryption device and the decryption device are connected to each other via a first transmission line serving as a physical transmission path, the encryption method comprising:
transmitting, by the management device, encryption information to the encryption device and the decryption device, the encryption information being related to an encryption scheme to be used in the encryption device and the decryption device;
generating, by the encryption device, encrypted data by performing an encryption process on communication data, based on the encryption information received from the management device, and transmitting, by the encryption device, the generated encrypted data to the decryption device via the first transmission line; and
performing, by the decryption device, a decryption process on the encrypted data received from the encryption device via the first transmission line, based on the encryption information received from the management device.
